(19) United States
(12) Patent Application Publication
(10) Pub. No.: US 2011/0199755 A1
(43) Pub. Date: Aug. 18, 2011

(54) LIGHT EMITTING DIODE HEAD-MOUNTABLE LIGHT

(75) Inventors: Jesse Falk, Las Vegas, NV (US); Ryan Bullen, Las Vegas, NV (US)

(73) Assignee: RAY OPTIC LLC, Las Vegas, NV (US)

(21) Appl. No.: 12/705,741

(22) Filed: Feb. 15, 2010

(51) Int. Cl. F21V 21/084

(52) U.S. Cl. 362/105

(57) ABSTRACT

A head-mountable light can include a support structure configured to be secured to a mounting structure that is configured to be secured to a person's head, and a light emitting diode supported in the support structure. The light can also include a lens supported in the support structure. A focal point of the lens can be located a focal distance from a surface vertex of the lens closest to the diode. Additionally, the diode can be positioned from 72 to 99 percent or from 101 to 104 percent of the focal distance from the surface vertex.

### TECHNICAL FIELD

The description relates to head-mountable lights.

### BACKGROUND

A loupe is a magnification device that can be used as a visual aid when performing tasks, such as tasks that require viewing small structures. Loupes can be configured to be supported on a person's head, such as by being attached to spectacles or a headband. Loupes are often used by surgeons and dentists to magnify a part of a patient's body when performing procedures on the patient.

A loupe light is a light that is configured to be attached to a loupe either directly or through one or more mounting structures. For example, a loupe and a loupe light may both be attached to a pair of glasses. Current loupe lights often utilize light emitting diodes (LED's) as light sources because of the small size and efficiency of LED's. Other types of head-mounted lights also exist.

### SUMMARY

Whatever the advantages of previous loupe lights, they have neither recognized the advantageous loupe light features described and claimed herein, nor the advantages that may be produced by such loupe light features.

The present inventors recognized shortcomings of prior head-mounted lights. For example, while some current head-mounted lights may be considered small, the present inventors recognized that it would be advantageous to produce a head-mounted light that is smaller than current head-mounted lights. The present inventors have also found that head-mounted light configurations discussed below could produce one or more optical properties that are superior to optical properties of current head-mounted lights. These properties may include increased brightness of the light, more even distribution of light across a light beam, and/or decreased scattering of light away from the light beam.

According to one embodiment, a light can include a support structure configured to be secured to a head mounting structure, and a light emitting diode supported in the support structure. The light can also include a lens supported in the support structure. A focal point of the lens can be located a focal distance from a surface vertex of the lens closest to the diode. The diode can be positioned from 72 to 99 percent or from 101 to 104 percent of the focal distance from the surface vertex.

According to another embodiment, a light apparatus can include a mounting structure configured to be secured to a person's head, and a light secured to the mounting structure. The light can include a support structure secured to the mounting structure, as well as a light emitting diode supported in the support structure. A lens can be supported in the structure, and the diode can be positioned from 6.4 to 8.8 millimeters or from 9.0 to 9.3 millimeters from a surface vertex of the lens on a side of the lens facing the diode.

According to yet another embodiment, a light can be secured to a mounting structure, and the mounting structure can be secured to a person's head. The light can include a support structure, as well as a light emitting diode and a lens supported in the support structure. A focal point of the lens can be located a focal distance from a surface vertex of the lens closest to the diode, and the diode can be positioned from 72 to 99 percent or from 101 to 104 percent of the focal distance from the surface vertex.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is an exploded perspective view of a light.

FIG. 2 is a perspective view of the light of FIG. 1.

FIG. 3 is a sectional view taken along line 3-3 of FIG. 2.

FIG. 4 is an enlarged cut-away sectional view of an area circumscribed by circular line 4 in FIG. 3.

FIG. 5 is a side view of a lens from the light of FIG. 1.

FIG. 6 is a perspective view of a light apparatus including a binocular loupe and a loupe light.

The description and drawings may refer to the same or similar features in different drawings with the same reference numbers.

### DETAILED DESCRIPTION

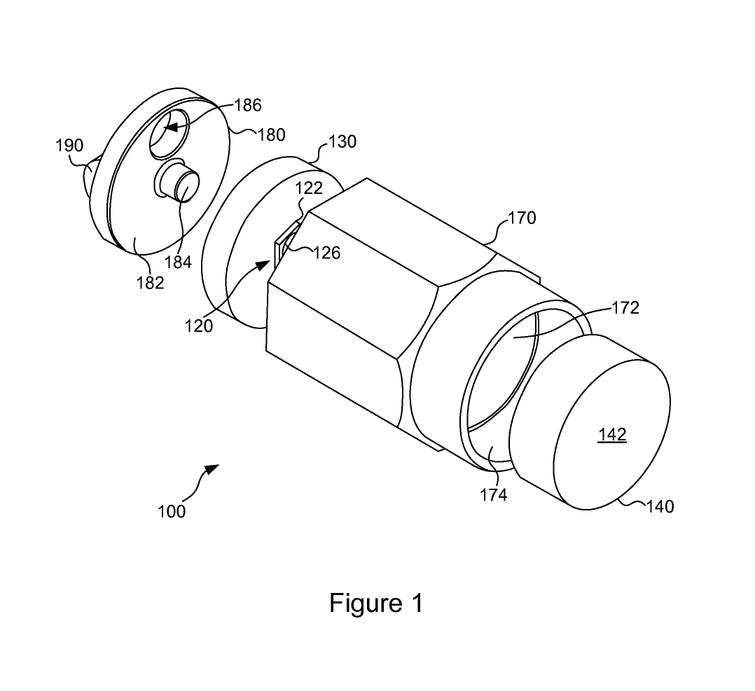

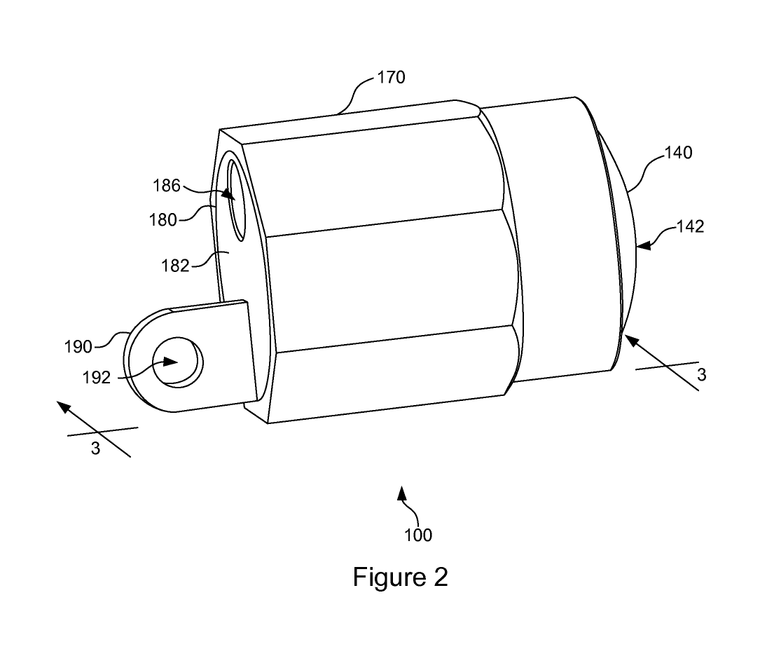

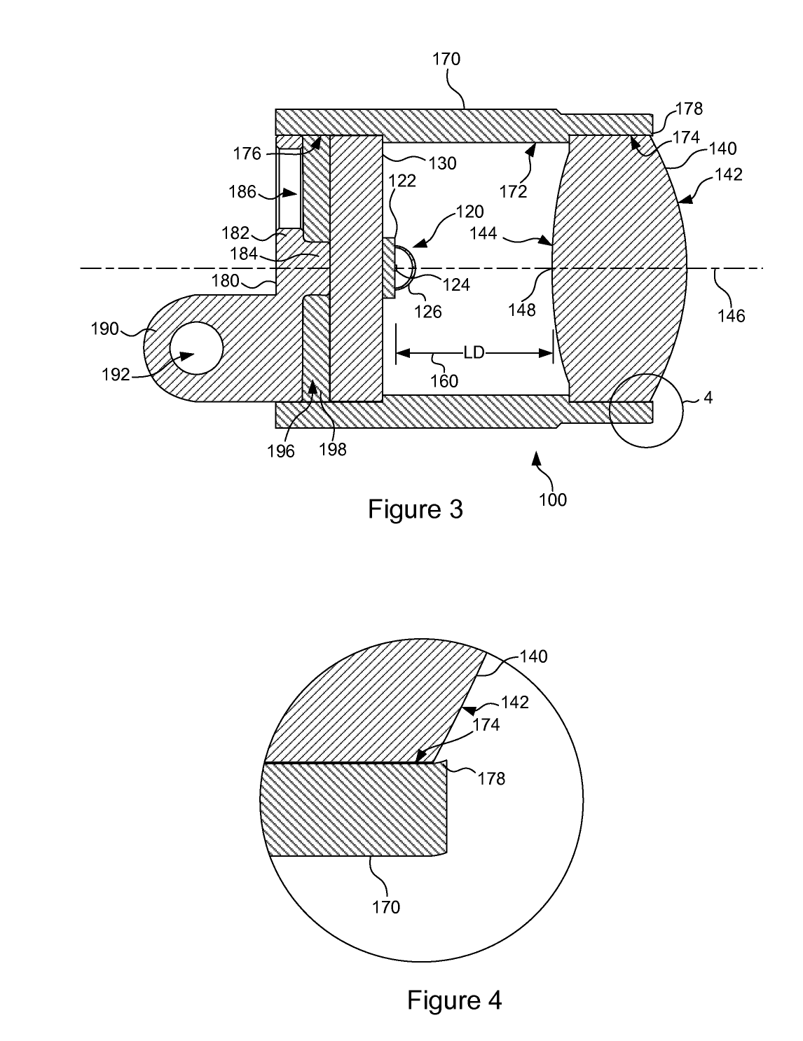

Referring to FIGS. 1-5, a light (100) includes an LED lamp (120) that is configured as a light source for the light (100). The LED lamp (120) can include an LED circuit chip (122) upon which an LED (124) is mounted. A transparent lamp cover (126) can also be mounted on the LED chip (122), and can extend around the LED (124) so that light from the LED passes through the lamp cover (126). The lamp cover (126) may be a lens that is able to focus light from the LED (124) so that it leaves the LED lamp (120) in a desired beam formation. As an example, the LED lamp (120) may be configured so that a beam leaves the LED lamp at a beam angle of about 125 degrees (from one side of the beam to another side of the beam). The LED lamp (120) may be an existing LED lamp. It can be desirable for the LED lamp (120) to be bright and efficient, and to have a small footprint. For example, it can be desirable for the LED lamp (120) to produce at least 200 lumens with an efficiency of at least 100 lumens per watt. It can also be desirable for the LED lamp (120) to have a footprint no greater than 16 square millimeters.

In one embodiment, the LED lamp (120) can be a model XLamp XP-G available from Cree, Inc., such as an XLamp XP-G model bins R4-S2 (e.g., R4, R5, or S2 bins) producing light ranging from 128 to 156 lumens at 350 milliamps (mA). For example, according to documents from Cree, Inc., the XLamp XP-G model R4 bin lamp has the following properties: (1) a maximum driving current of 1000 mA; (2) a typical flux of 135 lumens, and an efficiency of 128 lumens per watt when driven at 350 mA; (3) a typical flux of 251 lumens, and an efficiency of 112 lumens per watt when driven at 700 mA; (4) a typical flux of 335 lumens, and an efficiency of 102 lumens per watt when driven at 1000 mA; (5) a color of about 6000K. According to Cree, Inc., the XLamp XP-G model R4 bin lamp has a footprint of 3.45 mm by 3.45 mm (approximately 11.9 square millimeters). Cree, Inc. also reports that the XLamp XP-G model R4 bin lamp has a thermal resistance of 5.5 degrees Celsius per watt, an isolated thermal pad, moisture sensitivity level 1 (MSL 1) capability, and a small optical source.

Referring still to FIGS. 1-5, the LED lamp (120) can be mounted on a front side of a board (130), such as a printed board, using standard mounting techniques. It can be desirable for the board (130) to be made of a material that can conduct heat away from the LED lamp (120). As an example, the board (130) may be a metallic circuit board or an all-metal core circuit board. The board (130) can form a disk shape, and can include holes or recesses to allow wiring to pass between front and rear sides of the board (130). For example, the board (130) can include a pair of recesses that extend radially inward from opposing sides of the board (130) so that positive and negative leads can pass from a front side of the board (130) to a back side of the board (130).

A light lens (140) can be positioned in front of the LED lamp (120) to focus light from the LED lamp (120) into a light beam that exits the light (100). The inventors have found that it can be desirable to have a beam that remains tight with little scattered light, that captures as much light from the LED lamp (120) as possible, and that has an even lighting pattern. For example, the inventors have found that scattered light can produce discomfort for dental patients, even if such patients wear protective eyewear. In addition, uneven lighting can distort a user's view of an object that is illuminated by the light, such as an object viewed through a loupe where the light (100) is a loupe light. The inventors have found that existing head-mounted lights (i.e., lights configured to be mounted on a person's head such as by being secured to a head mounting structure) have been unable to produce desirable results in one or more of these areas, especially in configurations that allow an overall size of the light to remain small. For example, some such lights produce a ring or “doughnut”-shaped lighting pattern, especially in the outer areas of the light beam. The inventors have found that the lens configurations described below can produce surprisingly improved optical properties while allowing the overall size of the light to be small.

In one embodiment, the lens (140) can be a biconvex lens having a convex front surface (142) and a convex back surface (144) (although other types of lenses may also be used). A lens axis (146) passes through a back surface vertex (148) on the back surface (144) of the lens. The lens (140) can have a back focal point (150) that is located along the axis (146) a back focal length (152) from the back surface vertex (148). While the back focal length (152) may be any of various lengths in different configurations, the back focal length (152) can be about 8.9 millimeters with a light wavelength (lambda) of about 587 nanometers. The lens (140) can be made of any of various lens materials such as optical quality glass, but in one configuration, the lens (140) can be a PMMA (polymethyl-methacrylate) lens with an anti-reflective coating, which can reduce backscatter of light. The lens (140) can have an overall diameter that is the same as a diameter (154) of the convex front surface (142). The lens can also have a back surface diameter (156) that can be smaller than the front surface diameter (154). In one configuration, the front surface diameter (154) can be about 11.5 millimeters, and the back surface diameter (156) can be about 9.5 millimeters. The front surface (142) and the back surface (144) can have various curvatures to produce desired optical properties, such as desired focal lengths. In one configuration, the lens (140) can have an overall thickness of about 6 millimeters from front to back, and can have a front-to-back thickness of about 3.25 millimeters at its outer diameter. Lenses made from different materials (glass, etc.) and having different dimensions can be used, though it may be desirable to adjust other distances to match the changes in dimensions. For example, it may be desirable to keep ratios of the lens diameters to other parameters (e.g., focal lengths and distances from the lens (140) to the LED (124)) substantially consistent. It may also be desirable to have different dimensions for different LED lamps (120), which may produce light with different properties, such as different beam angles.

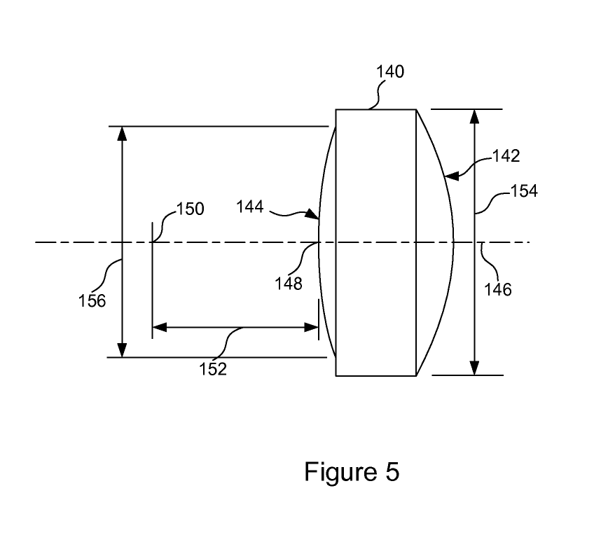

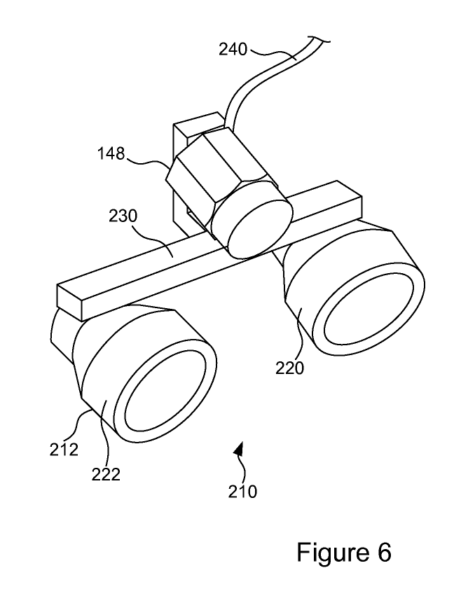

The inventors have found that surprisingly good optical properties (such as decreased light scattering, tighter light beam, increased brightness of the beam, decreased projection of images in the beam, and/or more even distribution of light across the beam) can be produced by maintaining a distance LD (160) (see FIG. 5) from the back surface vertex (148) to the LED (124) within certain ranges and/or within certain percentages of the back focal length (152) of the lens (140).

The inventors have found that it is it can be desirable for a lens to be positioned and sized so that it receives as much light as possible from the light source without receiving too much scatter light. The inventors have also found that bringing the lens (140) closer to the LED (124) can allow the lens (140) to receive more light, but it can also increase the size of the light beam and generate imperfections in the beam, as the lens (140) picked up scatter light from the LED (124). The inventors also found that as the distance LD (160) approached the back focal length (152) so that the LED (124) is positioned closer to the back focal point (150), the LED chip (122) can be projected in the light beam, thereby distorting a user's view of an object. The inventors have also found that as the distance LD (160) increases beyond the back focal length (152), then less light may be received by the lens (140) and the light beam can be dimmer.

To provide some examples, with a lens having a back focal length (152) of 8.9 millimeters, the inventors have found that keeping the distance LD (160) within a set of ranges that includes from 6.4 millimeters (72 percent of the back focal length (152)) to 8.8 millimeters (99 percent of the back focal length (152)) or from 9 millimeters (101 percent of the back focal length (152)) to 9.3 millimeters (104 percent of the back focal length (152)) can produce desirable results. The inventors have also found that with a back focal length (152) of 8.9 millimeters, keeping the distance LD (160) within a range of from 7.1 millimeters (80 percent of the back focal length (152)) to 8.6 millimeters (97 percent of the back focal length (152)) can produce even more desirable results. In addition, the inventors have found that with a back focal length (152) of 8.9 millimeters, keeping the distance LD (160) within a range of from 7.8 millimeters (88 percent of the back focal length (152)) to 8.5 millimeters (96 percent of the back focal length (152)) can produce even more desirable results. In one embodiment, the back focal length is 8.9, the front of the board (130) is 9 millimeters from the back surface vertex (148) of the lens (140), and the LED chip (122) is about 0.7 millimeters thick, so that the LED (124) is about 8.3 millimeters (93 percent of the back focal length (152)) from the back surface vertex (148). As an example of these optical properties, it has been found that a “doughnut”-shaped uneven distribution of light that persists in many existing head-mounted lights such as loupe lights can be decreased or eliminated, while still keeping the light small, keeping light scattering at low levels, and keeping the light beam tight. Also, it is believed that at these distances, a sufficient amount of light from the LED (124), such as about 70% of the LED light in some embodiments, travels directly to the back surface (144) of the lens (140), rather than hitting housing side walls or other features, with the lens (140) having a back surface diameter (156) of about 9.5 millimeters.

Referring still to FIGS. 1-5, the light (100) can include a support structure that supports the board (130) and the lens (140), thereby supporting the LED (124) in a desired position relative to the lens (140). The support structure can include a housing (170). The housing (170) can be a generally tube-shaped member with inner surfaces having a generally circular cross section and with much of an outer surface having an octagonal cross section. The inner surface of the housing can have a cylindrical central region (172), a cylindrical front region (174), which can have a diameter larger than the central region (172), and a cylindrical back region (176), which can also have a diameter larger than the central region (172). The cylindrical central region (172) is positioned so that at least a portion of it can receive light from the LED (124) without the light first passing through the lens (140). The central region (172) can be coated with an anti-reflective coating (i.e., a coating that reduces reflection as compared to the material upon which it is coated). For example, the central region (172) can be coated with an anodized flat black coating using standard techniques. The non-reflective coating can help to remove distortions, imperfections, and doughnut-shaped projections in the light beam. A front edge of the housing (170) can form an inward bend or crimp (178). The housing (170) could be different shapes, so long as it is configured to support the light lens (140) and the LED (124). The housing (170) can also be configured to protect the LED (124) and other internal components, such as the remainder of the LED lamp (120) and the board (130), such as by fully or partially enclosing them.

The lens (140) can be seated in the front region (174) of the lens (140), with the lens (140) abutting a shoulder between the front region (174) and the central region (172). The diameter of the front region (174) can be sufficient to form an interference fit with the lens (140), which can hold the lens (140) in place. In addition, the crimp (178) and the shoulder between the front region (174) and the central region (172) can keep the lens (140) from moving forward or backward relative to the housing (170). The lens (140) could be held in place in the housing (170) in some other way, such as solely with an interference fit or with an adhesive, such as epoxy.

The board (130) can be seated within the back region (176) of the housing (170) with the LED lamp (120) facing forward, and the board (130) abutting a shoulder between the back region (176) and the central region (172). The board (130) can have a diameter that is sufficient for the board (130) to form an interference fit with the back region (176) of the housing 170).

The support structure for the light (100) can also include a backing plate (180), which can be seated in the back region (176) of the housing (170) behind the board (130). The backing plate (180) can include a body in the form of a disk (182) that has a diameter sufficient to form an interference fit with the back region (176) of the housing (170). The back region (176) of the housing (170) can also include an outwardly-extending ring-shaped recess or an inwardly-extending ridge (not shown) that can be configured to engage an outer periphery of the disk (182), so that the disk (182) can snap into place when pressed into the back region (176). The backing plate can include a centrally-located knob (184) extending forward from the disk (182) to abut the board (130). The backing plate (180) can also define an access hole (186) that can be offset from the knob (184) and can extends axially through the disk (182). Wires from the board (130) and/or the LED lamp (120) can extend back through the access hole (186). For example, power cables for supplying power to drive the LED lamp (120) can extend back through the access hole (186) and to a power source (not shown). The backing plate (180) can also include a mounting support (190), which can be a protrusion extending back from the disk (182) on a side opposite the access hole (186). A mounting hole (192) can extend laterally through the mounting support (190). The mounting support (190) can be attached to a head mounting structure, such as a structure for a loupe or a structure for mounting to a headband or a pair of safety glasses. For example, the mounting support (190) can be attached to such a mounting structure via one or more interfaces or attachments designed to secure the mounting support (190) to a particular head mounting structure (not shown).

Because the knob (184) of the backing plate (180) extends forward from the backing plate disk (182) to contact the board (130), a gap (196) can be formed between the disk (182) and the board (130). That gap (196) can be filled with an adhesive material, such as a heat sink epoxy (198). The epoxy (198) can secure the backing plate (180) and the board (130) in place within the housing, and can assist in transmitting heat away from the board (130) to help keep the LED (124) from overheating.

It can be desirable for the housing (170) to be no longer than 20 millimeters in the direction of the axis (146) of the lens (140). In addition, it can be desirable for the housing to be no wider than 15 millimeters perpendicular to the axis (146) of the lens (140). In one embodiment, the housing is about 18 millimeters long in the direction of the axis (146) of the lens (140), and is about 14.4 to 14.6 millimeters wide from one peak of the octagonal cross section to an opposing peak of the octagonal cross section. A rounded portion in front of the octagonal section of the outer surface of the housing (170) (extending around the light lens (140)) can have an outer diameter of about 13 millimeters. It can be desirable for the overall light (100) to be no longer than about 21 millimeters, 20 millimeters, 19 millimeters, or 18 millimeters (excluding mounting support (190) or other mounting support structures).

The housing (170) and the backing plate (180) can both be made of standard materials. It can be desirable for such materials to be sufficiently durable and rigid to withstand normal use of a head-mounted light such as a loupe light. It can also be desirable for the materials to be good heat conductors so that they can conduct heat away from the LED (124) during use. In one embodiment, the housing (170) and the backing plate (180) can both be aircraft aluminum, such as 6061 aluminum. Heat sink epoxy (198) can also aid in conducting heat away from the LED (124) via the board (130). The board (130) can also be formed of materials that can conduct heat away from the LED (124).

The housing (170) and the backing plate (180) can be formed using standard tools and techniques, such as standard CNC mills and/or lathes and standard techniques. The housing (170) may be formed by cutting stock octagonal rods (which may be hollow) into sections and then forming the sections into desired shapes using a mill and/or lathe. The backing plate (180) can be formed by cutting circular stock rod into sections and forming the sections into the shapes of the backing plate (180), such as by using a 3 or 4-axis CNC mill. The LED lamp (120) can be mounted on the board (130) using standard mounting techniques.

Referring still to FIGS. 1-5, assembly of the light (100) will be described. The lens (140) can be pressed into the front region (174) of the housing (170) to form an interference fit between the lens (140) and the housing (170). In addition, a front edge of the housing (170) can be crimped to form the crimp (178). The board (130), with the LED lamp (120) mounted on it, can be pressed into the back region (176) of the housing (170) with the LED lamp (120) facing forward. Leads from the LED lamp (120) and/or the board (130) can be fed through the access hole in the backing plate (180), and the backing plate (180) can be pressed into the back region (176) of the housing (170) so that the knob (184) abuts the board (130). As noted above, the housing (170) may include a ridge or recess to engage the backing plate (180) so that the backing plate (180) can “snap” into position. The epoxy (198) can be fed into the area behind the board (130) prior to seating the backing plate (180), so that the epoxy (198) fills the gap (196) between the board (130) and the backing plate (180) after the backing plate (180) is seated. Once the epoxy is cured, it can assist in holding the board (130) and the backing plate (180) in place in the housing (170).

Referring now to FIG. 6, the light (100) can be included in a light apparatus (210), such as a loupe apparatus. The light apparatus (210) can also include a head mounting structure such as a standard loupe (212), which can be a binocular loupe with a left eyepiece (220) and a right eyepiece (222). The eyepieces (220 and 222) can be supported by a loupe support structure (230). The loupe support structure (230) can also include a light mounting structure (not shown). An attachment or interface (not shown) can be attached to the light mounting structure and to the loupe light mounting support (190 in FIGS. 1-5) to secure the light (100) to the loupe support structure (230). A power supply line (240) can include positive and negative leads for driving the light (100). The power supply line (240) can be connected to a power supply (not shown), such as a battery pack or power outlet. The loupe support structure can also be attached to a headband or to a pair of glasses to hold the light apparatus (210) with the eyepieces (220 and 222) of the loupe (212) aligned with a user's eyes and with the light (100) focusing a beam on an area that the user can see through the eyepieces (220 and 222).

As noted above, the beneficial features of the light (100) can provide a better experience for a user of the light (100). However, the subject matter defined in the appended claims is not necessarily limited to the benefits described herein. A particular implementation of the invention may provide all, some, or none of the benefits described herein.

It may be desirable for the light housing to include fins or other structures to increase its outer surface area, thereby increasing the exchange of heat away from the light to prevent overheating of the LED. For example, lateral grooves can be cut into the peaks of the octagonal-shaped outer surface of the housing to form fins to assist in conducting heat away from the housing and away from the light. For example, the lateral grooves can be formed using a CNC lathe.

While the invention has been particularly shown and described with reference to preferred embodiments thereof, it will be understood by those skilled in the art that various changes in form and details may be made therein without departing from the spirit and scope of the invention. For example, the housing may be a different shape or made from different materials from those described above, a different LED lamp may be used, a different lens may be used, etc.

I claim:

1. A head mountable light comprising:
a support structure configured to be attached to a head mounting structure;
a light emitting diode supported in the support structure;
a lens supported in the support structure, a focal point of the lens being located a focal distance from a surface vertex of the lens closest to the diode, and the diode being positioned from 72 to 99 percent or from 101 to 104 percent of the focal distance from the surface vertex.

2. The light of claim 1, wherein the support structure comprises a region that is positioned to receive light from the light emitting diode without the light passing through the lens, and the region comprises an anti-reflective coating.

3. The light of claim 1, wherein the diode is positioned from 80 to 97 percent of the focal distance from the surface vertex.

4. The light of claim 1, wherein the diode is positioned from 88 to 96 percent of the focal distance from the surface vertex.

5. The light of claim 1, wherein the diode is positioned from 6.4 to 8.8 millimeters from the surface vertex.

6. The light of claim 1, wherein the diode is positioned from 7.1 to 8.6 millimeters from the surface vertex.

7. The light of claim 1, wherein the diode is positioned from 7.8 to 8.5 millimeters from the surface vertex.

8. The light of claim 1, wherein the lens comprises an antireflective coating.

9. The light of claim 1, wherein the diode is able to produce 200 lumens or more with an efficiency of at least 100 lumens per watt.

10. The light of claim 1, wherein the diode is part of a light emitting diode lamp that has a footprint no greater than 16 square millimeters.

11. The light of claim 1, wherein the diode is part of an XLamp XP-G light emitting diode lamp.

12. The light of claim 1, wherein the support structure comprises a housing that is no longer than 20 millimeters along an axis of the lens.

13. The light of claim 1, wherein the support structure comprises a housing that is no wider than 15 millimeters perpendicular to an axis of the lens.

14. The light of claim 1, wherein the diode is mounted on a front side of a board, and wherein the support structure comprises a backing plate behind the board and an adhesive between the backing plate and the board.

15. The light of claim 14, wherein the adhesive comprises heat sink epoxy.

16. The light of claim 1, wherein the light is a loupe light and the head mounting structure is a loupe structure.

17. A light apparatus comprising:
a mounting structure configured to be secured to a person's head;
a light secured to the mounting structure, the light comprising:
a support structure secured to the mounting structure;
a light emitting diode supported in the support structure;
a lens supported in the support structure, the support structure comprising a region that is positioned to receive light from the light emitting diode without the light passing through the lens, and the region comprises an anti-reflective coating.

18. The light apparatus of claim 17, wherein the diode is positioned from 6.4 to 8.8 millimeters or from 9.0 millimeters to 9.3 millimeters from a surface vertex of the lens on a side of the lens facing the diode.

19. The light apparatus of claim 17, wherein the light is a loupe light and the mounting structure is a loupe mounting structure.

20. The light apparatus of claim 17, wherein a focal point of the lens is located a focal distance from the surface vertex, and the diode is positioned from 72 to 99 percent of the focal distance from the surface vertex.

21. The light apparatus of claim 19, wherein the diode is positioned from 7.1 to 8.6 millimeters from the surface vertex on the side of the lens facing the diode, and wherein the diode is positioned from 80 to 97 percent of the focal distance from the surface vertex.

22. The light apparatus of claim 19, wherein the diode is positioned from 7.8 to 8.5 millimeters from the surface vertex on the side of the lens facing the diode, and wherein the diode is positioned from 88 to 96 percent of the focal distance from the surface vertex.

23. A method comprising:
securing a light to a mounting structure, the light comprising:
a support structure;
a light emitting diode supported in the support structure; and
a lens supported in the support structure, a focal point of the lens being located a focal distance from a surface vertex of the lens closest to the diode, and the diode being positioned from 72 to 99 percent or from 101 to 104 percent of the focal distance from the surface vertex; and
securing the mounting structure to a person's head.

24. The method of claim 23, wherein the light is a loupe light and the mounting structure is a loupe mounting structure.

25. The method of claim 23, wherein the diode is positioned from 7.1 to 8.6 millimeters from the surface vertex on the side of the lens facing the diode, and wherein the diode is positioned from 80 to 97 percent of the focal distance from the surface vertex.

26. The method of claim 23, wherein the diode is positioned from 7.8 to 8.5 millimeters from the surface vertex on the side of the lens facing the diode, and wherein the diode is positioned from 88 to 96 percent of the focal distance from the surface vertex.

27. The method of claim 23, wherein an outer diameter of the lens is from 8 to 12 millimeters.

28. The method of claim 23, wherein the support structure comprises a region that is positioned to receive light from the light emitting diode without the light passing through the lens, and the region comprises an anti-reflective coating.
